(19) United States
(12) Patent Application Publication
(10) Pub. No.: US 2026/0021850 A1
(43) Pub. Date: Jan. 22, 2026

(54) EXTRUDED RAIL JOINTS FOR SANDWICH PANELS IN A VEHICLE

(71) Applicant: Anjani Kumar, Northville, MI (US)

(72) Inventor: Anjani Kumar, Northville, MI (US)

(21) Appl. No.: 19/270,698

(22) Filed: Jul. 16, 2025

Related U.S. Application Data
(60) Provisional application No. 63/671,786, filed on Jul. 16, 2024.

(51) Int. Cl. B62D 27/02; B62D 25/02; B62D 25/06; B62D 25/20; F16B 5/02

(52) U.S. Cl. CPC B62D 27/026; B62D 25/02; B62D 25/06; B62D 25/2036; F16B 5/02

(57) ABSTRACT

A vehicle system for joining sandwich panels has been designed for use in vehicles. The system includes a chassis, a floor, sidewalls, a roof, and a rear panel. The walls are formed as prefabricated sandwich panels with finished surfaces. These panels are joined using single-piece aluminum extrusions in the form of roof rails and floor rails, which allow for quick assembly and strong surface-to-surface load transfer. The sandwich panels use lightweight cores and embedded stiffeners. The rails are designed to enable rotational assembly that compresses adhesive beads for robust connections. The floor is made from modular extruded panels with staggered seams and integrated tracks, and a removable closeout cover is provided for access to wiring and electronics. The design of the system supports both strong mechanical attachment and efficient manufacturing, while reducing overall vehicle weight and assembly time. The system helps maintain structural integrity under safety testing conditions.

### CROSS REFERENCE TO RELATED APPLICATIONS

This application claims the benefit of U.S. Patent Application No. 63/671,786, filed Jul. 16, 2024, which is hereby incorporated by reference.

### BACKGROUND

Typically, multi-passenger buses and other vehicles are constructed of a chassis onto which a frame, often made of metal such as steel, is built. Attached onto the frame are exterior panels, which are often aluminum or fiberglass. Interior panels are attached to the frame to form the interior of the vehicle.

Multi-passenger vehicles, since they carry passengers that often do not wear restraints such as seatbelts, are subject to rigorous safety and crash test standards. However, since the frame is rigid and the panels are made of malleable, brittle materials, a crash or rollover of the vehicle results in the panels and frame deforming and/or breaking, causing serious injury to passengers. This results in a limited residual space (i.e., a survival zone for passengers) within the passenger compartment of the bus or vehicle.

Reinforcement measures have been implemented to increase the structural integrity of present frames and panels. For example, steel plates or other heavy, durable materials are appended to the frame and/or panels to increase their structural integrity.

Moreover, sandwich type panel constructions have also been used, such as to build recreational vehicles. These include sandwich panel core material such as polystyrene, paper, metal honeycomb, foamed polyurethane, plywood, or fibrous boards. A sandwich panel facing material (such as steel, aluminum, plywood, hardboard, or fiberglass-reinforced plastic) is then bonded to the core materials and any reinforcing member.

However, these reinforcement techniques (i.e., steel plates and sandwich type panels) cause the vehicle to become excessively heavy, expensive and labor intensive to assemble.

Thus, there is a need for improvement in this field.

### SUMMARY

Traditional vehicle construction for multi-passenger buses and trucks has relied on rigid metal frames and panels made from malleable or brittle materials. Reinforcement with steel plates or heavy panels has been used to meet safety requirements, but these methods have resulted in excessive vehicle weight, higher manufacturing costs, and more complex assembly processes. These approaches also limit flexibility in interior layouts and complicate repairs or modifications.

Through development and testing, it was discovered that single-piece aluminum extrusions used as roof rails and floor rails can provide structural strength comparable to commercial-grade steel, while also reducing weight and enhancing corrosion resistance. Aluminum alloys such as 6061-T6 allow for the integration of multiple structural and functional features into a single component, which was found to further enhance the overall performance of the assembled vehicle compartment. This integration reduces the number of parts and assembly steps, supporting faster and more cost-effective manufacturing.

It was found that sandwich panels constructed with lightweight foam or wood cores and bonded impact-resistant skins are capable of meeting most safety standards, including Federal Motor Vehicle Safety Standard (FMVSS) 220 roof crush resistance. These panels can be precisely cut using Computer Numerical Control (CNC) routing and hot wire cutting techniques, allowing for complex shapes, embedded stiffeners, and internal tunnels for wiring or hoses. The use of expanded polystyrene foam as a core material was found to be particularly suitable for this manufacturing process, resulting in panels that are both lightweight and structurally robust.

Testing revealed that a rotational insertion technique for joining sandwich panels to the extruded rails enables optimal compression of adhesive beads, producing stronger bonds between high surface energy materials. The inclusion of features such as retention flanges, adhesion flanges, and indexing tabs in the extruded rails was found to facilitate precise alignment, strong adhesion, and enhanced load transfer across the assembled structure. This approach minimizes the need for exposed fasteners and glue seams, resulting in a cleaner appearance and enhanced perceived quality.

A unique modular floor system was also developed. The modular floor system has staggered seams and integrates a brace bracket, which enhances visual appeal and structural stability during assembly. The use of prefabricated panels with finished surfaces was found to reduce the need for additional finishing work, supporting rapid assembly and consistent quality. The modular design also allows for quick changes in seating layouts and straightforward replacement of damaged exterior panels, which is valuable for commercial vehicle operators.

Overall, the combination of lightweight sandwich panels, single-piece aluminum extrusions, and advanced assembly techniques provides a practical and efficient solution for constructing vehicle compartments. The findings demonstrate that this system can deliver structural integrity, reduced weight, and manufacturing flexibility, while meeting rigorous safety standards and supporting a high-quality finished appearance.

The systems and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a vehicle system.

Aspect 3 generally concerns the system of any previous aspect including a vehicle.

Aspect 4 generally concerns the system of any previous aspect in which the vehicle has a chassis.

Aspect 5 generally concerns the system of any previous aspect in which the vehicle has a cabin.

Aspect 6 generally concerns the system of any previous aspect in which the vehicle is a body-on-frame type vehicle.

Aspect 7 generally concerns the system of any previous aspect in which the vehicle has a frame.

Aspect 8 generally concerns the system of any previous aspect in which the vehicle has a compartment.

Aspect 9 generally concerns the system of any previous aspect in which the compartment is secured to the frame.

Aspect 10 generally concerns the system of any previous aspect in which the compartment is secured to the chassis.

Aspect 11 generally concerns the system of any previous aspect in which the compartment includes a cargo area.

Aspect 12 generally concerns the system of any previous aspect in which the compartment includes a passenger compartment.

Aspect 13 generally concerns the system of any previous aspect in which the compartment is box-shaped.

Aspect 14 generally concerns the system of any previous aspect in which the compartment defines a compartment cavity.

Aspect 15 generally concerns the system of any previous aspect in which the compartment includes a floor.

Aspect 16 generally concerns the system of any previous aspect in which the floor is mounted to the frame.

Aspect 17 generally concerns the system of any previous aspect in which the floor includes a floor system.

Aspect 18 generally concerns the system of any previous aspect in which the floor system includes tracks assembled together.

Aspect 19 generally concerns the system of any previous aspect in which the tracks define mounting channels.

Aspect 20 generally concerns the system of any previous aspect in which the tracks are made of extruded aluminum.

Aspect 21 generally concerns the system of any previous aspect in which the tracks are staggered to form a staggered seam.

Aspect 22 generally concerns the system of any previous aspect in which the floor system includes a brace bracket attached across the staggered seam.

Aspect 23 generally concerns the system of any previous aspect in which the brace bracket has brace fasteners that secure the brace bracket to the tracks.

Aspect 24 generally concerns the system of any previous aspect in which the tracks form two or more panels.

Aspect 25 generally concerns the system of any previous aspect in which the compartment includes a sidewall.

Aspect 26 generally concerns the system of any previous aspect in which the sidewall includes a sandwich panel.

Aspect 27 generally concerns the system of any previous aspect in which the sandwich panel is prefabricated.

Aspect 28 generally concerns the system of any previous aspect in which the sandwich panel includes a core covered by one or more skins.

Aspect 29 generally concerns the system of any previous aspect in which the core has a low density.

Aspect 30 generally concerns the system of any previous aspect in which the core is lightweight.

Aspect 31 generally concerns the system of any previous aspect in which the core is a foam core.

Aspect 32 generally concerns the system of any previous aspect in which the skins are impact resistant.

Aspect 33 generally concerns the system of any previous aspect in which the skins are finished.

Aspect 34 generally concerns the system of any previous aspect in which the skins form finished interior and exterior surfaces of the compartment.

Aspect 35 generally concerns the system of any previous aspect in which the skins are made of fiber reinforced material.

Aspect 36 generally concerns the system of any previous aspect in which the compartment includes a roof.

Aspect 37 generally concerns the system of any previous aspect in which the roof includes a sandwich panel.

Aspect 38 generally concerns the system of any previous aspect in which the core has an exterior surface that is curved.

Aspect 39 generally concerns the system of any previous aspect in which the core defines a tunnel.

Aspect 40 generally concerns the system of any previous aspect in which the tunnel is defined in the exterior surface.

Aspect 41 generally concerns the system of any previous aspect in which the tunnel extends along a longitudinal axis of the vehicle.

Aspect 42 generally concerns the system of any previous aspect in which the tunnel is centered at the thickest part of the core.

Aspect 43 generally concerns the system of any previous aspect in which the core has an interior surface.

Aspect 44 generally concerns the system of any previous aspect in which the core defines a cutout.

Aspect 45 generally concerns the system of any previous aspect in which the cutout is defined in the interior surface of the core.

Aspect 46 generally concerns the system of any previous aspect in which the sandwich panel has a stiffener.

Aspect 47 generally concerns the system of any previous aspect in which the stiffener extends within the cutout.

Aspect 48 generally concerns the system of any previous aspect in which the cutout extends transverse to the tunnel.

Aspect 49 generally concerns the system of any previous aspect in which the stiffener extends transverse to the longitudinal axis.

Aspect 50 generally concerns the system of any previous aspect in which the compartment includes a rear panel.

Aspect 51 generally concerns the system of any previous aspect in which the rear panel includes a sandwich panel.

Aspect 52 generally concerns the system of any previous aspect in which the sandwich panel defines one or more windows.

Aspect 53 generally concerns the system of any previous aspect in which the stiffeners brace the windows.

Aspect 54 generally concerns the system of any previous aspect in which the compartment includes a rail.

Aspect 55 generally concerns the system of any previous aspect in which the rail includes a roof rail.

Aspect 56 generally concerns the system of any previous aspect in which the rail includes a floor rail.

Aspect 57 generally concerns the system of any previous aspect in which the rail is a single-piece extrusion.

Aspect 58 generally concerns the system of any previous aspect in which the rail is an aluminum extrusion.

Aspect 59 generally concerns the system of any previous aspect in which the rail is made from an aluminum alloy.

Aspect 60 generally concerns the system of any previous aspect in which the aluminum alloy is a 6061-T6 aluminum alloy.

Aspect 61 generally concerns the system of any previous aspect in which the rail is adhered to the sandwich panel.

Aspect 62 generally concerns the system of any previous aspect in which the sandwich panel has a glue bead.

Aspect 63 generally concerns the system of any previous aspect in which the glue bead is positioned on one of the skins of the sandwich panel.

Aspect 64 generally concerns the system of any previous aspect in which the skins are high surface energy materials.

Aspect 65 generally concerns the system of any previous aspect in which the rail is made of a high surface energy material.

Aspect 66 generally concerns the system of any previous aspect in which the glue bead is compressed between the rail and the sandwich panel.

Aspect 67 generally concerns the system of any previous aspect in which the glue bead is compressed between the rail and the sandwich panel via a rotational motion.

Aspect 68 generally concerns the system of any previous aspect in which the compartment has a sidewall fastener securing the rail to the sidewall.

Aspect 69 generally concerns the system of any previous aspect in which the sidewall fastener temporarily secures the sidewall to the rail.

Aspect 70 generally concerns the system of any previous aspect in which the sidewall fastener is a self-tapping type fastener.

Aspect 71 generally concerns the system of any previous aspect in which the sidewall fastener is a self-tapping screw.

Aspect 72 generally concerns the system of any previous aspect in which the rail is configured to provide surface-to-surface load transfer to the sandwich panel.

Aspect 73 generally concerns the system of any previous aspect in which the compartment has a rain gutter.

Aspect 74 generally concerns the system of any previous aspect in which the rain gutter is configured to hide an opening created by the sidewall fastener.

Aspect 75 generally concerns the system of any previous aspect in which the roof rail has a sidewall connector connected to the sidewall.

Aspect 76 generally concerns the system of any previous aspect in which the roof rail has a roof connector connected to the roof.

Aspect 77 generally concerns the system of any previous aspect in which the roof rails has a transition section extending between the sidewall connector and the roof connector.

Aspect 78 generally concerns the system of any previous aspect in which the sidewall connector has a retention flange and an adhesion flange that define a sidewall channel where an edge of the sidewall is received.

Aspect 79 generally concerns the system of any previous aspect in which the retention flange is shorter than the adhesion flange.

Aspect 80 generally concerns the system of any previous aspect in which the roof rail is adhered to the sidewall at the adhesion flange.

Aspect 81 generally concerns the system of any previous aspect in which the sidewall fastener is secured to the adhesion flange to promote curing.

Aspect 82 generally concerns the system of any previous aspect in which the adhesion flange has one or more indexing tabs.

Aspect 83 generally concerns the system of any previous aspect in which the compartment has a track.

Aspect 84 generally concerns the system of any previous aspect in which the track engages the indexing tabs.

Aspect 85 generally concerns the system of any previous aspect in which the roof connector has a base that defines a roof recess.

Aspect 86 generally concerns the system of any previous aspect in which the roof is adhered to the base at the roof recess.

Aspect 87 generally concerns the system of any previous aspect in which the roof has a retainer.

Aspect 88 generally concerns the system of any previous aspect in which the roof rail has a retainer.

Aspect 89 generally concerns the system of any previous aspect in which the compartment has a closeout cover.

Aspect 90 generally concerns the system of any previous aspect in which the closeout cover has a flexible arm secured to the retainer.

Aspect 91 generally concerns the system of any previous aspect in which the floor rail is adhered to the sidewall.

Aspect 92 generally concerns the system of any previous aspect in which the floor rail has a retention lip and an adhesion wall receiving the sidewall.

Aspect 93 generally concerns the system of any previous aspect in which the retention lip is shorter than the adhesion wall.

Aspect 94 generally concerns the system of any previous aspect in which the adhesion wall has a glue bead compressed between the adhesion wall and the sidewall.

Aspect 95 generally concerns the system of any previous aspect in which the glue bead is compressed between the adhesion wall and the sidewall via relative rotational motion.

Aspect 96 generally concerns the system of any previous aspect in which the compartment has a skirt panel adhered to the floor rail.

Aspect 97 generally concerns the system of any previous aspect in which the skirt panel is adhered to the floor rail via a rotational motion.

Aspect 98 generally concerns the system of any previous aspect in which the floor defines a guide channel.

Aspect 99 generally concerns the system of any previous aspect in which the floor rail has a guide rib received in the guide channel.

Aspect 100 generally concerns the system of any previous aspect in which the compartment has a glue bead compressed between the guide rib and the frame at the guide channel.

Aspect 101 generally concerns the system of any previous aspect in which the frame has a tongue.

Aspect 102 generally concerns the system of any previous aspect in which the guide rib defines a groove.

Aspect 103 generally concerns the system of any previous aspect in which the tongue is received in the groove.

Aspect 104 generally concerns the system of any previous aspect in which the groover is tapered to align the floor rail with the floor.

Aspect 105 generally concerns the system of any previous aspect in which the vehicle has a wheel well.

Aspect 106 generally concerns the system of any previous aspect in which the wheel well forms a wheel hump inside the compartment.

Aspect 107 generally concerns the system of any previous aspect in which the vehicle has a seat mounted over the wheel hump.

Aspect 108 generally concerns the system of any previous aspect in which the compartment has a wall track mounted to the sidewall.

Aspect 109 generally concerns the system of any previous aspect in which the wall track is adhered to the sandwich panel.

Aspect 110 generally concerns the system of any previous aspect in which the seat is secured to the wall track.

Aspect 111 generally concerns the system of any previous aspect in which the wall track is wider than conventional tracks.

Aspect 112 generally concerns the system of any previous aspect in which the wall track has one or more scores configured to receive glue.

Aspect 113 generally concerns the system of any previous aspect in which the compartment is configured to pass an FMVSS 220 test.

Aspect 114 generally concerns the system of any previous aspect in which the compartment is configured to satisfy FMVSS 207/210.

Aspect 115 generally concerns the system of any previous aspect in which the compartment includes a sandwich panel.

Aspect 116 generally concerns the system of any previous aspect in which the rail is adhered to the sidewall.

Aspect 117 generally concerns the system of any previous aspect including a fastener securing the sandwich panel to the rail.

Aspect 118 generally concerns a method.

Aspect 119 generally concerns the method of any previous aspect including applying a glue bead.

Aspect 120 generally concerns the method of any previous aspect including positioning a sidewall and a rail at a transverse orientation.

Aspect 121 generally concerns the method of any previous aspect including compressing the glue bead via rotational motion relative between the sidewall and the rail.

Aspect 122 generally concerns the method of any previous aspect including inserting a rail onto a sidewall at an acute angle relative to the sidewall.

Aspect 123 generally concerns the method of any previous aspect including compressing the glue bead via rotational motion between the sandwich panel and the rail.

Aspect 124 generally concerns the method of any previous aspect in which the applying includes applying the glue bead to the rail.

Aspect 125 generally concerns the method of any previous aspect including applying the glue bead onto the sandwich panel.

Aspect 126 generally concerns the method of any previous aspect including fastening the sandwich panel to the rail via a self-tapping fastener.

Aspect 127 generally concerns the method of any previous aspect including fastening the sidewall to the rail via a self-tapping fastener.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a bottom perspective view of a vehicle system according to one example.

FIG. 2 is a top perspective view of the FIG. 1 vehicle system.

FIG. 3 is an enlarged perspective view of the FIG. 1 vehicle system.

FIG. 4 is an exploded view of a roof for the FIG. 1 vehicle system.

FIG. 5 is an exploded view of a chassis and a floor system according to one example that can be used in the FIG. 1 vehicle system.

FIG. 6 is a top view of a floor system for the FIG. 1 vehicle system according to another example.

FIG. 7 is an enlarged perspective view of the FIG. 6 floor system.

FIG. 8 is a perspective view of the FIG. 6 floor system that includes a brace bracket.

FIG. 9 is a top perspective view of the FIG. 6 floor system.

FIG. 10 is an enlarged cross-sectional view of a sidewall and a roof rail of the FIG. 1 vehicle system using an assembly technique according to one example.

FIG. 11 is an enlarged cross-sectional view of the sidewall and the roof rail using an assembly technique according to another example.

FIG. 12 is an enlarged cross-sectional view of the sidewall and the roof rail using an assembly technique according to a further example.

FIG. 13 is an enlarged perspective view of the sidewall secured to the roof via the roof rail.

FIG. 14 is an exploded perspective view of a closeout cover, the sidewall, and the roof.

FIG. 15 is an enlarged perspective view of the closeout cover when secured to the sidewall and the roof.

FIG. 16 is an enlarged cross-sectional view of the sidewall when mounted to the chassis via the floor rail according to one example.

FIG. 17 is an enlarged perspective view of the sidewall when mounted to the chassis via the floor rail according to another example.

FIG. 18 is a rear perspective view of a seat mounted over a wheel hump and to a wall track adhered to the sidewall.

FIG. 19 is an enlarged perspective view of the FIG. 18 wall track.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

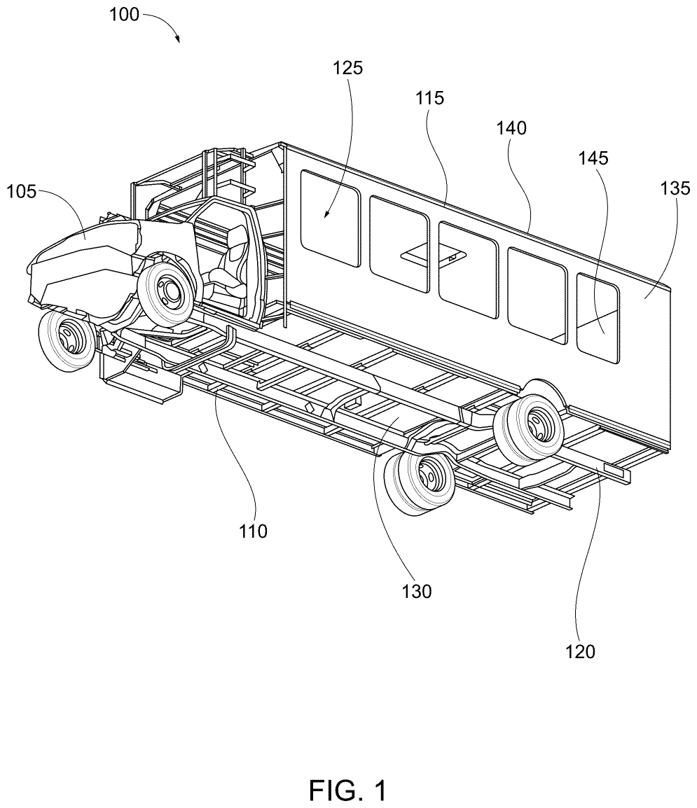

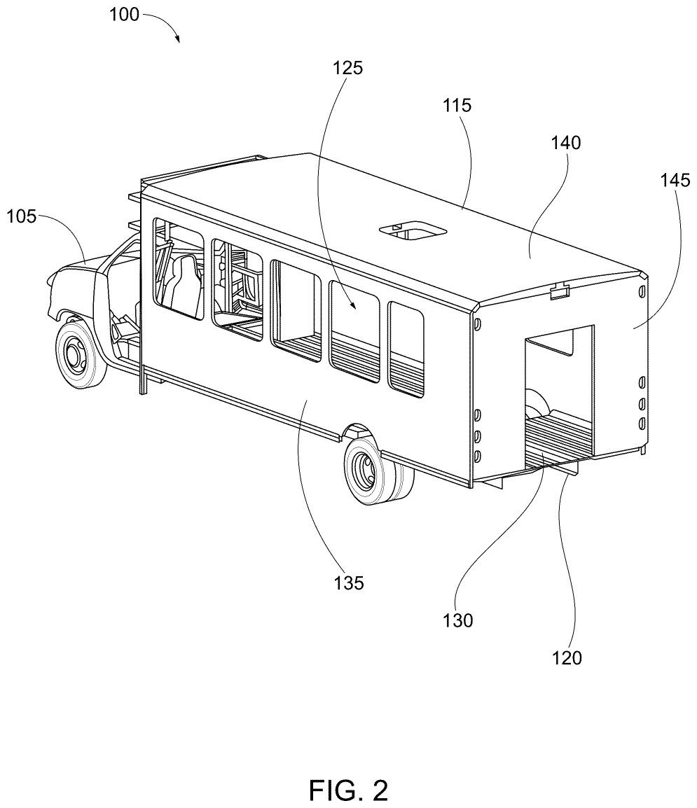

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

Referring to FIGS. 1 and 2, a vehicle system 100 includes a vehicle 105 with a chassis 110 and a compartment 115, such as in the form of a cargo area or passenger compartment, mounted to the chassis 110 of the vehicle 105. In the illustrated example, the vehicle 105 includes a truck, but it should be recognized that the vehicle 105 can include other types of vehicles like buses. For instance, the chassis 110 of the vehicle 105 in the depicted example includes a frame 120 such that the vehicle 105 has a body-on-frame type construction. In the illustrated example, the compartment 115 of the vehicle 105 is enclosed to define a compartment cavity 125 where cargo is stored, or the same space can be used for passenger seating.

When the vehicle 105 is used to carry passengers in the compartment cavity 125, the compartment 115 typically has to satisfy stringent safety and crash standards. As mentioned before, traditional designs typically added additional reinforcement structures, such as steel plates, to help satisfy these safety standards. However, these additional reinforcement structures and other measures added weight that reduced vehicle mileage. Moreover, these additional reinforcement structures made traditional vehicles more difficult to assemble and more expensive. The compartment 115 of the vehicle system 100 has been designed to satisfy stringent safety tests for passengers, and at the same time, the compartment 115 is configured to be assembled quickly and inexpensively.

In the illustrated example, the compartment 115 has a floor 130 that is mounted to the frame 120, one or more sidewalls 135 extending from the floor 130, and a roof 140 attached to the sidewalls 135 to cover the compartment cavity 125. The compartment 115 further has a rear panel 145 that is located at the rear of the vehicle 105. The rear panel 145 connects the sidewall 135 and the roof 140 together. The floor 130, the sidewalls 135, the roof 140 and the rear panel 145 are connected together to form the compartment cavity 125 of the vehicle 105. In one example, the floor 130, the sidewalls 135, the roof 140 and the rear panel 145 are prefabricated parts with interior and/or exterior surfaces that are partially or fully finished for final use. By using these prefabricated or finished parts, the compartment 115 is generally prepared by the time the compartment 115 is assembled. This in turn facilitates quick assembly of the finished compartment 115 along with the rest of the vehicle system 100. In some cases, the compartment cavity 125 is ready in just a few hours with most of the interior and exterior of the compartment 115 ready for use. In other variations, some, but not all, of these parts of the compartment 115 are prefabricated or finished.

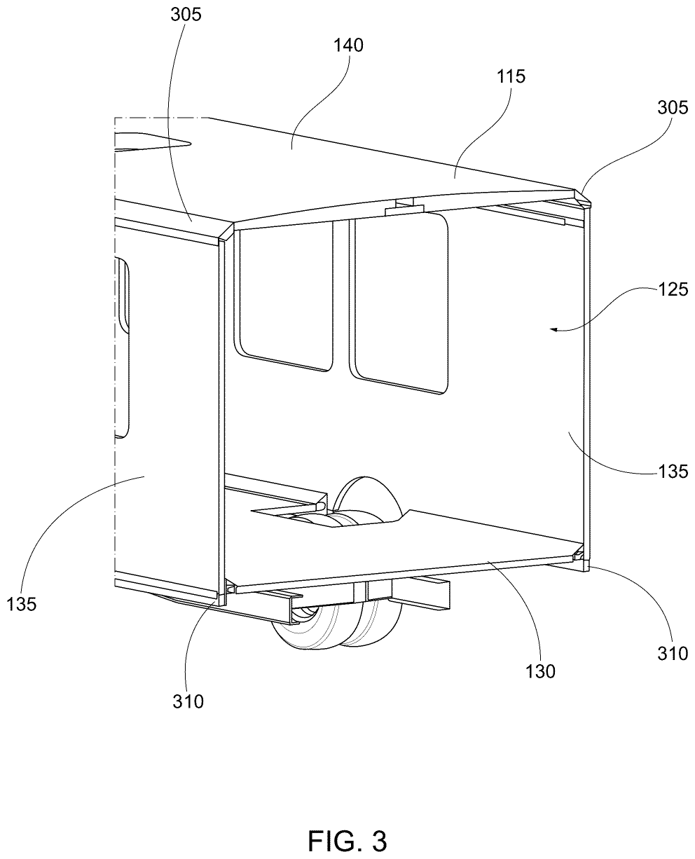

FIG. 3 shows an enlarged, rear perspective view of the compartment 115 when the floor 130, the sidewalls 135, and the roof 140 are assembled together. As can be seen, the sidewalls 135 are connected to the roof 140 via one or more roof rails 305. In the illustrated example, the sidewalls 135, which are located on opposing sides of the compartment 115, are connected to the roof 140 via two roof rails 305, but the sidewalls 135 can be secured to the roof 140 with more or less roof rails 305 in other examples. The sidewalls 135 are further secured to the floor 130 via one or more floor rails 310. In the depicted example, the sidewalls 135 are connected to the floor 130 via two roof rails 305, but the sidewalls 135 can be secured to the floor 130 with more or less floor rails 310 in other examples. The roof rail 305 and the floor rail 310 are configured to facilitate quick assembly of the compartment 115.

In some versions, the roof rail 305 and floor rail 310 are extruded parts, and in one particular version, the roof rail 305 and the floor rail 310 are in the forms of single-piece aluminum extrusions. Producing the roof rail 305 and the floor rail 310 as single-piece aluminum extrusions make the roof rail 305 and the floor rail 310 lightweight and corrosion-resistant. Moreover, using a single-piece aluminum extrusion process provides a cost-effective and labor-efficient method to manufacture the roof rail 305 and the floor rail 310. In one form, the roof rail 305 and the floor rail 310 are made from aluminum alloys such as 6061-T6. It was discovered that aluminum alloys, such as 6061-T6, provide the required yield strength comparable to commercial-grade steel, while also enabling the integration of multiple structural and functional features into one component. These integrated features enhance the structural performance of the extrusion even further.

The roof rail 305 and the floor rail 310 facilitate a strong and robust connection between the floor 130, the sidewalls 135, and the roof 140. With the roof rail 305 and the floor rail 310, the floor 130, the sidewalls 135, and the roof 140 are able to interlock and insert into one another, forming the compartment cavity 125 that is robust enough to meet FMVSS 220 roof crush resistance requirements. This connection strategy with the roof rail 305 and the floor rail 310 ensures that structural loads are transferred through surface-to-surface contact, rather than relying solely on fasteners or adhesive joints, resulting in stronger and more reliable load paths.

In one variation, the sidewall 135, the roof 140, and the rear panel 145 are made with sandwich panels. Sandwich panels are lightweight so as to make assembly of the compartment cavity 125 easier as well as enhance fuel efficiency of the vehicle 105. It was also discovered that the sandwich panels were structurally strong enough to meet most safety standards. The sandwich panels forming the sidewalls 135, the roof 140, and the rear panel 145 in most cases have pre-finished interior and exterior surfaces which again help to simplify and speed up the assembly process for the compartment cavity 125. A sandwich panel is typically made by gluing two sheets of skin over a core. The skin is usually made from an impact resistant material like a fiber reinforced material (e.g., fiber reinforced plastic), metal, and/or a composite material. To reduce weight, the core is commonly made from a lightweight or low-density material such as foam and/or wood. Sometimes stiffeners are placed inside the core to give extra strength. Such stiffeners can be solid or hollow, and the stiffeners are typically made from a rigid material such as aluminum, steel, wood, and/or a composite material.

The sandwich panels for the sidewalls 135 and the roof 140 are generally manufactured in a similar fashion. For example, after gluing the covers to the core, the sidewall 135 in one version is put on a large table and routed with a Computer Numerical Control (CNC) router to create a precise outer perimeter for the sidewall 135 with one or more inner window cutouts in the sidewall 135. Before the gluing process, stiffeners are sometimes provided within the sandwich panel where extra strength is needed, such as between two or more windows, at one or more rack attachment locations, at one or more seat or wheelchair tie down attachment locations, and the like. Cavities can also be provided in the core that can be used to route wires and/or hoses.

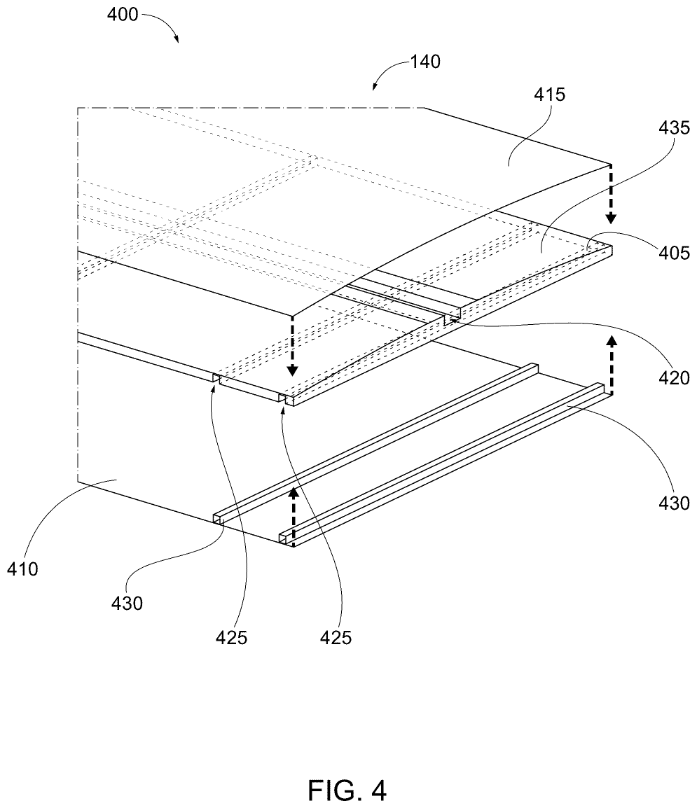

As noted before, the sandwich panels forming the sidewalls 135, the roof 140, and the rear panel 145 can be generally made using similar manufacturing processes. One example of a process for making the sandwich panel for the roof 140 will be initially described with respect to FIG. 4. As should be recognized, the sandwich panels for the sidewalls 135 and the rear panel 145 can be manufactured in a similar fashion as shown in FIG. 4, and the sandwich panels forming the sidewalls 135 can include the same or similar components.

FIG. 4 shows an exploded view of a roof sandwich panel 400 that forms the roof 140 of the compartment 115 according to one example. As should be recognized, the roof sandwich panel 400 can be configured differently in other examples depending on the needs for a particular use case. In the illustrated example, the roof sandwich panel 400 of the roof 140 is made by gluing a roof core 405 with an inner skin 410 and an outer skin 415. As shown, the roof core 405 is sandwiched between the inner skin 410 and the outer skin 415. The inner skin 410 and the outer skin 415 are bonded to the roof core 405 via an adhesive. The roof core 405 in the depicted example is made of a foam material, but the roof core 405 in other variations can be made from other low-density materials such as wood. The inner skin 410 and the outer skin 415 in the depicted example are made from a fiber reinforced material, such as a fiber reinforced plastic material, but the inner skin 410 and the outer skin 415 can be made from other impact resistant materials such as metal and/or a composite material.

The roof core 405 in the illustrated example defines a tunnel 420 that runs from the front to the back of the vehicle 105 in a continuous, longitudinal manner. The tunnel 420 can be for example used to pass the electrical harnesses, hoses and/or refrigerant lines. In other examples, the tunnel 420 extends along only part of the roof 140 such that the tunnel 420 does not fully extend from the front to the rear of the compartment 115 in the vehicle 105. In the depicted example, the roof core 405 further defines one or more cutouts 425 configured to receive one or more stiffeners 430. The stiffeners 430 are embedded in the cutouts 425 of the roof core 405 to stiffen the roof sandwich panel 400 of the roof 140. The stiffeners 430 are made of a rigid material such as metal and/or a fiber reinforced material. In the illustrated example, the stiffeners 430 are hollow to reduce weight, but in other examples, the stiffeners 430 can be solid. The stiffeners 430 provide structural support for the roof 140 to withstand forces applied during various safety tests such as the FMVSS 220 roof crush test. The FMVSS 220 roof crush test evaluates the structural integrity of the roof 140 by applying a load equal to 1.5 times the empty vehicle weight, ensuring the assembly can endure severe compressive forces without excessive deformation. The stiffeners 430 can further serve as support or mounting points for subsystems such as for air conditioners and roof hatches.

As shown, the outer surface 435 of the roof core 405 is curved to give the roof 140 an overall curved or bowed shape to promote water drainage from the roof 140. When the outer skin 415 is glued to the roof core 405, the outer skin 415 takes the shape of the outer surface 435 of the roof core 405 such that the roof 140 has the curved shape. The tunnel 420 and the cutouts 425 are formed in opposite surfaces of the roof core 405, and the tunnel 420 and the cutouts 425 extend transverse to one another. When the roof sandwich panel 400 is assembled, the tunnel 420 extends in a longitudinal direction relative to the vehicle 105 and the stiffeners 430 extend generally in a lateral direction relative to the vehicle 105. With the tunnel 420 and the cutouts 425 extending transverse to one another in the roof core 405, the stiffeners 430 do not restrict the tunnel 420 from passing conduits because the tunnel 420 and the cutouts 425 are located at different levels within the roof core 405. With the curved shape, the thickness of the roof core 405 is thicker at the center, longitudinal axis of the vehicle 105 and is thinner at the along the side edges of the roof 140 at the sidewalls 135. With the center of the roof core 405 for the roof 140 being thicker, the tunnel 420 is positioned to extend along the central longitudinal axis of the roof 140 without interference by the stiffeners 430.

In one example, the roof core 405 is cut by a CNC hot wire cutting machine. The CNC hot wire cutting machine is able to inexpensively and precisely cut complex shapes with multiple cavities and curves. It was found that having the roof core 405 made of expanded polystyrene (EPS) foam was especially suitable for cutting by the CNC hot wire cutting machine. The EPS foam is lightweight and is able to be cut efficiently with the hot wire cutting machine. A vacuum bag process is subsequently used to glue the roof core 405, the outer skin 415, and the stiffeners 430 together into a single piece to form the roof sandwich panel 400.

It was found that the sandwich panel for the sidewall 135 has a simpler design as compared to the roof core 405, because the sidewall 135 does not need to be curved. As a result, the core for the sidewall 135 is not required to be cut into a complex curved shape. With the simplicity of the shape of the sidewall 135, it was discovered that many other types of other core materials can be used such as polyethylene (PET) foam and/or wood.

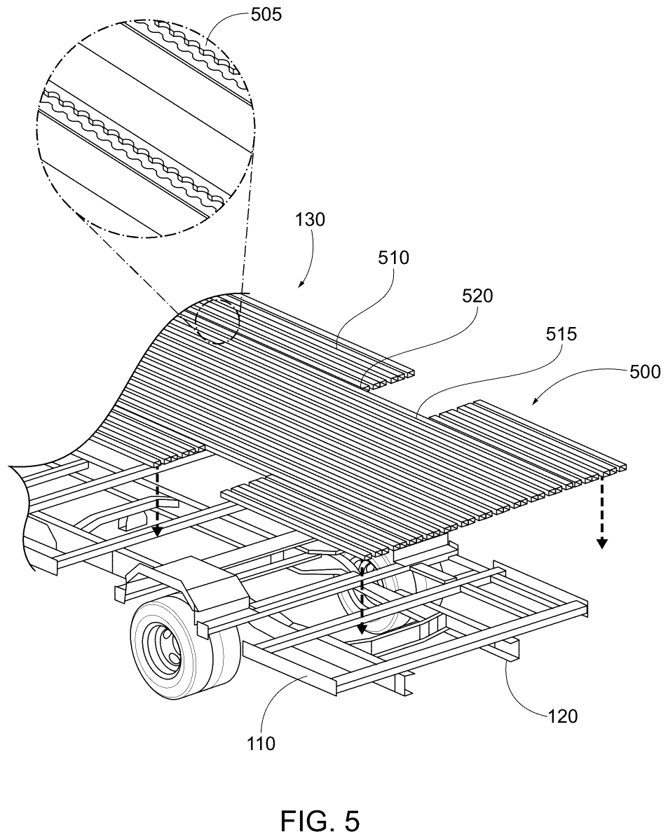

FIG. 5 illustrates the floor 130 mounted on the frame 120. As shown, the floor 130 includes a floor system 500 that is made by interconnected floor panels. In one example, the floor panels are aluminum extruded flooring panels. In some cases, each flooring panel has a track 505. This type of flooring system provides flexibility to change the location of seats and wheelchairs as needed.

The floor system 500 comes together as a single assembly and is glued to the chassis 110. The floor panels can be fastened and/or glued one by one to the chassis 110, but installing the floor system 500 as a single unitary structure that glued to the chassis 110 is simpler. Traditionally, this type of flooring system is installed in vans due to the relatively shorter length of the van, and this type flooring system is not installed on the chassis 110 and the frame 120 of the type of vehicle 105 shown in FIG. 1. The length of the vehicle 105 in FIG. 1 is too long for installation of the flooring system. If the length of the floor system 500 is too long (e.g., greater than about 150 inches to 200 inches), it is challenging to make floor panels for the floor system 500 with a single extrusion length. The floor system 500 becomes costly to not only manufacture and machine, but the longer extrusions for the floor panels are also too costly to ship, package, and handle. To address this extrusion length issue, the floor system 500 in FIG. 5 is divided into a first section 510 and a second section 515. The first section 510 and the second section 515 are joined at a floor seam 520. The floor seam 520 creates an undesirable appearance from a passenger perspective, deteriorating the overall look of the floor inside the passenger compartment.

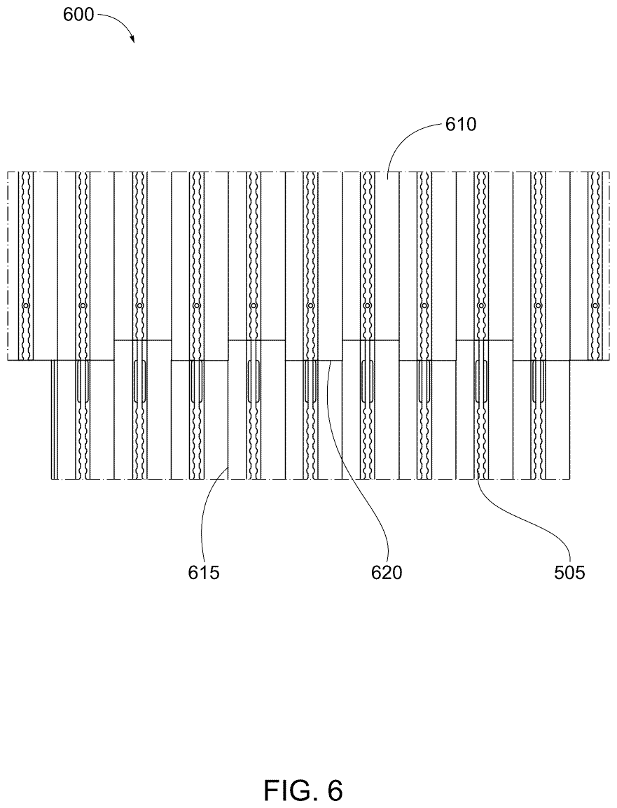

FIG. 6 illustrates a floor system 600 that reduces or even eliminates the above-mentioned issues with respect to the floor seam 520 in FIG. 5. As can be seen, the floor system 600 has the tracks 505 of a first section 610 and a second section 615 connected to form a floor seam 620 with a staggered pattern. This staggered pattern of the floor seam 620 in the FIG. 6 floor system 600 tends to be more visually appealing.

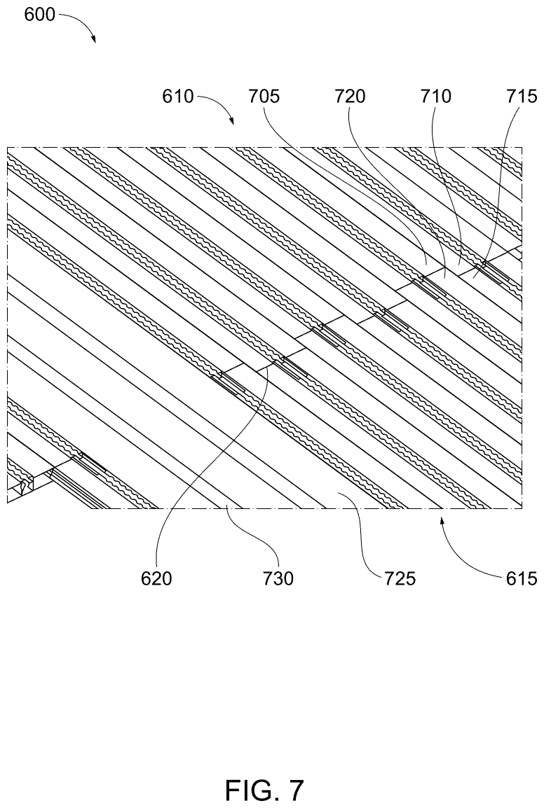

FIG. 7 illustrates a similar staggered pattern in an isometric view. In the illustrated example, four separate panels, a first panel 705, a second panel 710, a third panel 715, and a fourth panel 720, interlock with each other, to create a planer surface that can eliminate the unsightly seam. As can be seen, the first panel 705, the second panel 710, the third panel 715, and the fourth panel 720 created the floor seam 620 with the staggered pattern. The staggered pattern of four (4) panels forces them to become co-planar to each other. This joint gets completely hidden after installing a peal and stick type floor covering 725 over the staggered floor seam 620 so as to eliminate any visibility of the floor seam 620. In some versions, the joint in the L-track area is hidden by a track cover 730 that can be made of a plastic extrusion.

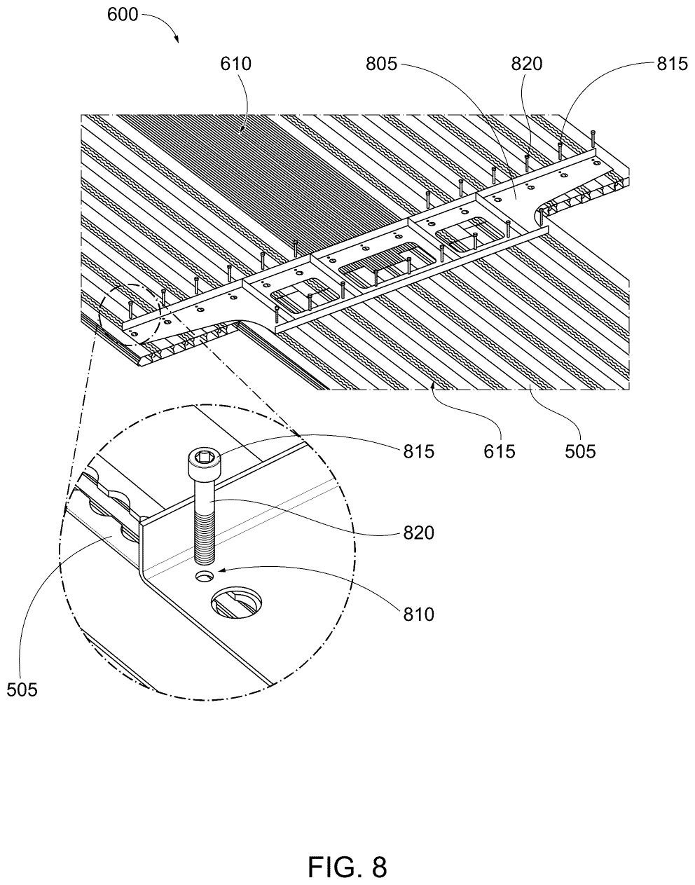

FIG. 8 illustrates that after staggering the panels and joining the first section 610 and the second section 615, a brace bracket 805 is connected to both the first section 610 and the second section 615, to keep floor system 600 together until assembled/glued to the chassis 110. The brace bracket 805 gives the connection of first section 610 and the second section 615 structural stability during assembly. The brace bracket 805 has one or more holes 810 made in the same pitch or spacing as the L-track. The holes 810 are arranged an array in the brace bracket 805. The holes 810 receive one or more brace fasteners 815 that connect the brace bracket 805 to the track 505 of the first section 610 and the second section 615. In the depicted example, the brace fastener 815 is in the form of a bolt 820, but other types of fasteners can be used in other examples. The brace fasteners 815 in conjunction with the brace bracket 805 keeps all the tracks 505 connected at a precise spacing such that the floor system 500 is kept structurally integrated until glued and/or bolted to the chassis 110.

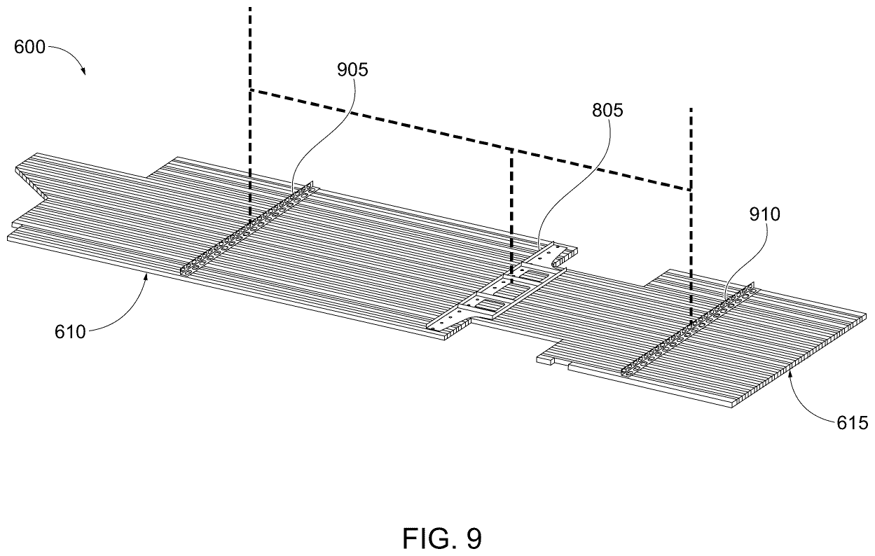

FIG. 9 Illustrates how the floor system 600 is lifted at three (3) points. One lifting point is in the middle of the floor system 600 at the brace bracket 805. The other two lifting points include a first hanger 905 located near the front of the floor system 600 and a second hanger 910 that is located near the rear of the floor system 600 of the vehicle 105. The floor system 500 is picked up at multiple points. Due to the large size, the weight of the floor system 600 can cause the floor system 600 to sag, but when the same floor system 600 is glued to the chassis 110, the combined structure gains substantial stiffness.

Traditionally, vehicles do not use structural extrusions to join the floor to the sidewall and the sidewall to the roof. Instead, the floor, the sidewalls, and the roof are normally connected via a joint or connector made of steel. As should be recognized, steel is quite heavy and requires bolting or other fabrication to secure the parts together. After this, inner and outer closeout panels are glued and sealed or riveted to hide the joints between the sidewalls, the floor, and the roof. The excessive number of glue seams and exposed fasteners in these traditional vehicles give a sense of poor perceived quality.

The vehicle system 100 is designed to use single-piece aluminum extrusions in the form of the roof rails 305 and the floor rails 310 that are glued to the sandwich panels forming the sidewalls 135 and the roof sandwich panel 400 of the roof 140. As mentioned before, the sandwich panels that form the sidewall 135, the roof 140, and the rear panel 145 come with finished interior and exterior surfaces. These sandwich panels are adequately stiff, lightweight, and dimensionally precise such that the sandwich panels can be cut with a CNC router.

When gluing at least two surfaces together, an adhesive, such as in the form of a glue bead, is applied to at least one of the two surfaces. The two surfaces are then moved closer to each other until the surfaces butt together. The glue bead that is placed between the surfaces is compressed so as to provide an effective glue strength. If a glue bead is placed between the two surfaces and then the surfaces are slid against each other, the glue strength tends to not be as strong as compared to when the surfaces are directly butted against one another. In other words, for two parts to have a strong adhesion, the glue bead should squish between the two surfaces for an effective connection to happen. Moreover, the adhesive strength is typically better when high surface energy material surfaces are glued together.

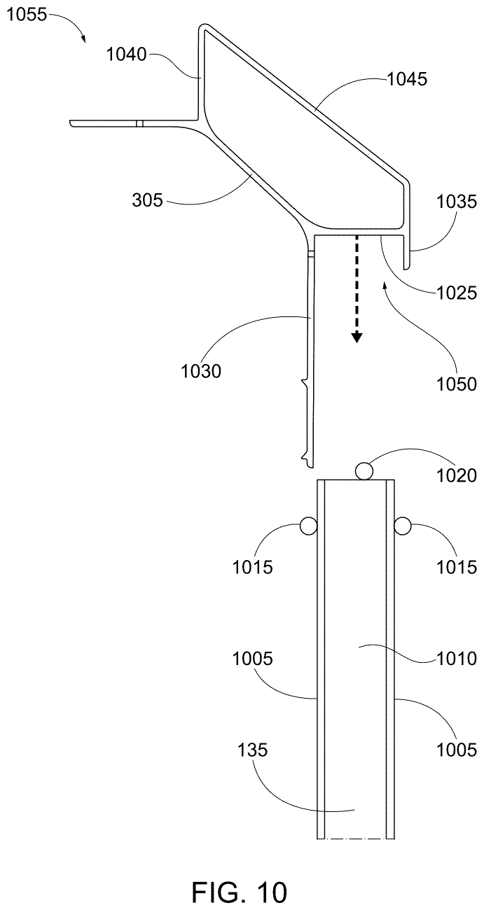

FIG. 10 illustrates one way of attaching the sidewall 135 to the roof rail 305. The sidewall 135 is a single part made of one or more skins 1005 and a wall core 1010. The wall core 1010 is sandwiched between the skins 1005. The skins 1005 are bonded to the wall core 1010 via an adhesive. The wall core 1010 in the depicted example is made of a foam material, but the wall core 1010 in other variations can be made from other low-density materials such as wood. The skins 1005 in the depicted example are made from a fiber reinforced material, such as a fiber reinforced plastic material, but the inner skin 410 and the outer skin 415 can be made from other impact resistant materials such as metal and/or a composite material.

As can be seen, one or more side glue beads 1015 and one or more end glue beads 1020 are applied to the sidewall 135 to adhere the sidewall 135 to the roof rail 305. The side glue bead 1015 and the end glue bead 1020 are applied before dropping and assembling the roof rail 305 over the sidewall 135. The insertion of the roof rail 305 over the sidewall 135 drives the side glue bead 1015 away from a bonding surface 1030, and only the end glue bead 1020 is compressed over a resting surface 1025 to give effective adhesion. The end glue bead 1020 still does not provide proper adhesion because the wall core 1010 is a low surface energy part. For the adhesion to be effective, the sandwich panel can bond on the surface of the skin 1005 that has a high surface energy.

The roof rail 305 extends longitudinally between the sidewall 135 and the roof 140. The roof rail 305 has a sidewall connector 1035 that connects to the sidewall 135 and a roof connector 1040 that connects to the roof 140. The sidewall connector 1035 and the roof connector 1040 generally extend transverse or perpendicular to one another. As can be seen, the roof rail 305 further has a transition section 1045 that connects the sidewall connector 1035 to the roof connector 1040. The transition section 1045 acts to bevel or transition the sharp corner between the sidewall connector 1035 and the roof connector 1040. In one form, the sidewall connector 1035 and the roof connector 1040 extend at an oblique angle relative to the transition section 1045. In the illustrated example, the transition section 1045 is hollow to reduce weight. As should be appreciated, the shape of the roof rail 305 is easy to extrude and provides significant strength.

As shown, the sidewall connector 1035 defines a sidewall channel 1050 that receives an edge of the sidewall 135. The sidewall connector 1035 at the sidewall channel 1050 has the resting surface 1025 and the bonding surface 1030. The roof connector 1040 defines a roof recess 1055 that is configured to secure and support the roof 140.

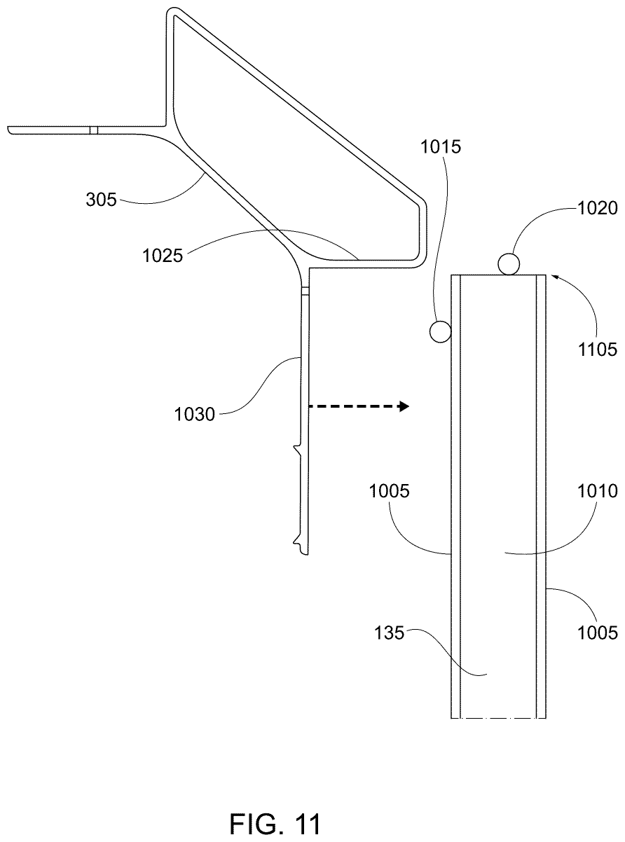

FIG. 11 illustrates another way of assembling the sidewall 135 to the roof rail 305. If the roof rail 305 is attached in a sideways direction, the side glue bead 1015 is adequately compressed to provide a proper adhesion on a high energy surface of the skin 1005 and the bonding surface 1030. However, it was found that this method leaves an ugly looking opening 1105 on the other side that has to be closed with and additional part which increases the cost, assembly time, and weight of the vehicle 105. Such a design also gives poor perceived quality and can create water leaks.

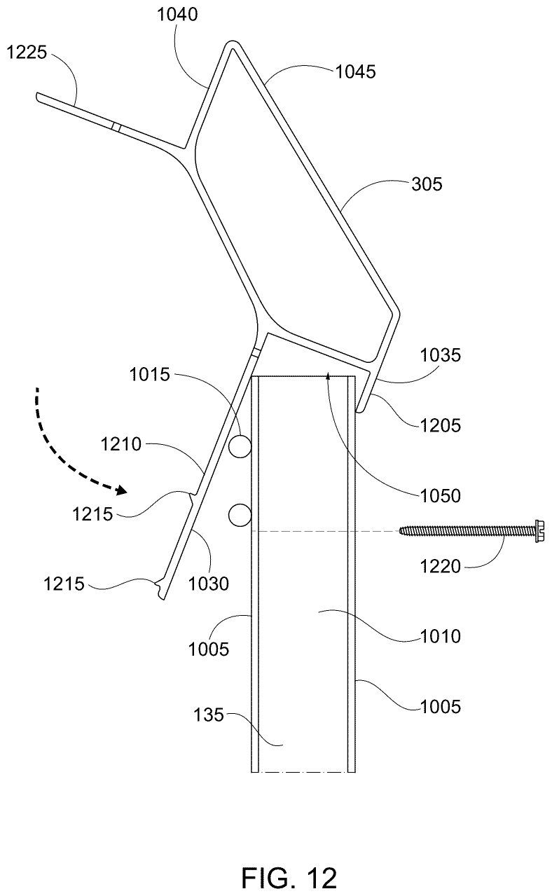

FIG. 12 illustrates an enhanced way of assembling the sidewall 135 to the roof rail 305, that is by way of rotation. The rotation enables the side glue bead 1015 to be compressed between the roof rail 305 and the skin 1005. At the sidewall connector 1035, the roof rail 305 has a retention flange 1205 and an adhesion flange 1210 that define the sidewall channel 1050. To facilitate the rotational movement during insertion of the sidewall 135 into the sidewall channel 1050, the retention flange 1205 is shorter than the adhesion flange 1210. If the retention flange 1205 and the adhesion flange 1210 were the same length, the sidewall 135 would need to be inserted in the manner as shown in FIG. 10. While shorter than the adhesion flange 1210, the retention flange 1205 is long enough to cover the exposed edge of the sidewall 135 and should eliminate the need to add another part to close the seam between the roof rail 305 and the sidewall 135. The adhesion flange 1210 of the roof rail 305 includes one or more indexing tabs 1215, and in the illustrated example, the adhesion flange 1210 has at least two indexing tabs 1215.

In some cases, just rotating and gluing does not create enough pressure for the glue bead to compress properly. To address this, a sidewall fastener 1220, such as in the form of a self-tapping fastener, is secured through the sidewall 135 from the side opposite to the adhesion flange 1210 to pull the adhesion flange 1210 towards the sidewall 135 to facilitate bonding. In the depicted example, the sidewall fastener 1220 engages the adhesion flange 1210 in between the indexing tabs 1215. Once the glue cures, the sidewall fastener 1220 can be removed from the sidewall 135 if so desired.

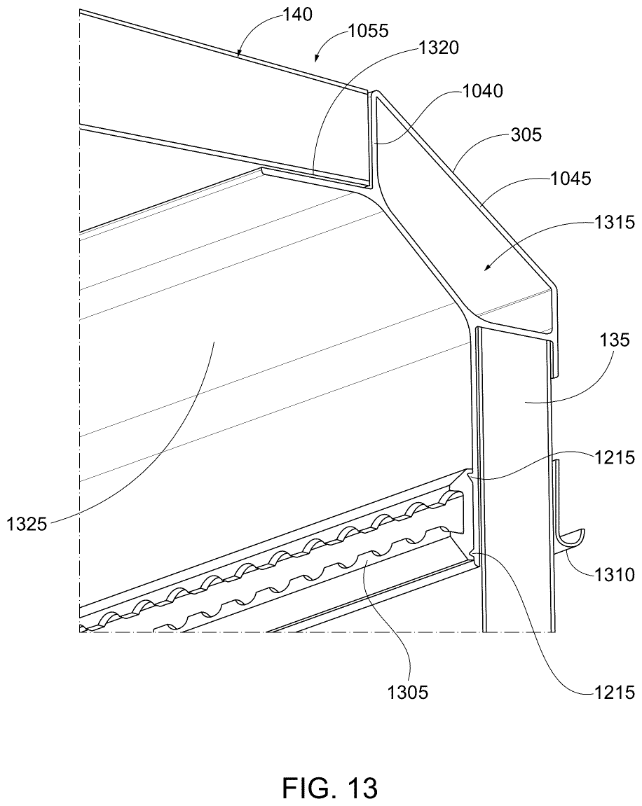

FIG. 13 illustrates multiple features integrated into the single piece roof rail 305 such as the indexing tabs 1215. The indexing tabs 1215 are inserted into the indentation in a track 1305. The indexing tabs 1215 not only helps to locate the track 1305 in the right place but enables the track to withstand larger loads when the load is applied in a transverse direction to the indexing tabs 1215 (e.g., in a vertical direction). In buses, this kind of track 1305 is commonly used to connect the shoulder belt of the wheelchair. When the load is pulled in a downward direction, the indexing tabs 1215 help to withstand the downward load. The track 1305 is typically installed after the glue cures and the sidewall fastener 1220 is uninstalled. A hole created due to the installation of the sidewall fastener 1220 is covered with a peel and stick rain gutter 1310 that can be made from a plastic or metal extrusion. On the other side, the same hole is covered by the track 1305.

FIG. 13 further illustrates a transition cavity 1315 in the roof rail 305 that can be for example used to pass one or more conduits and/or hoses. The roof connector 1040 at the roof recess 1055 of the roof rail 305 has a base 1320 on which the roof 140 rests and is adhered to the roof rail 305. The track 1305, which is installed over the indexing tabs 1215, has one or more holes that are machined. In one form, the track 1305 is made short enough so that the track 1305 can be handled efficiently for machining the holes. Machining a very long part on any machine is cumbersome. With the track 1305 being initially separate from the roof rail 305, the roof rail 305 can be long so as to extend for the full length of the compartment 115. in one version, the track 1305 is approximately four feet long so as to facilitate easy machining of the holes via a vertical milling machine. As shown, the transition section 1045 of the roof rail 305 has a mounting surface 1325 that can be used to attach one or more accessories such as a camera and/or lights.

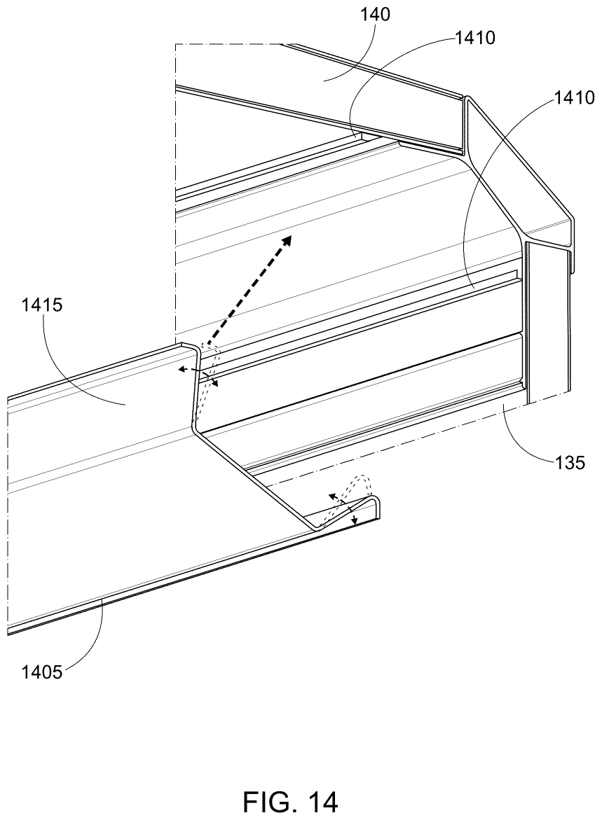

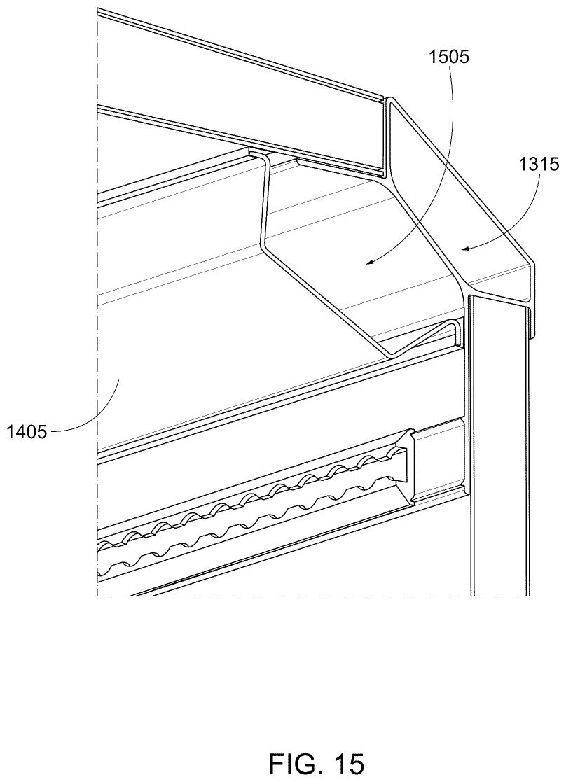

Certain vehicles, such as passenger buses, typically include interior electronics (e.g., camera and lights) that need frequent servicing. To hide any wiring and/or conduits, the vehicle system 100 includes a closeout cover 1405 as is shown in FIGS. 14 and 15. FIG. 14 illustrates the closeout cover 1405 during assembly, and FIG. 15 shows the closeout cover 1405 after assembly.

Referring to FIG. 14, the closeout cover 1405 in the depicted example is installed on one or more retainers 1410. As shown, one of the retainers 1410 is installed on the roof rail 305 and the other on the roof 140. In the depicted example, the retainers 1410 each have a J-shape, but the retainers 1410 in other examples can be shaped differently. For instance, the retainers 1410 can include other shapes and structures that hold the closeout cover 1405 in place, such as those having an L-shape or a U-shape section, or even a slot. In one form, the closeout cover 1405 is made with relatively flexible material such as plastic. The closeout cover 1405 in the depicted example has one or more flexible arms 1415. During installation, the flexible arms 1415 of the closeout cover 1405 are inwardly flexed and then snapped into the retainers 1410. With this clipped connection between the closeout cover 1405 and the retainers 1410, the closeout cover 1405 can be uninstalled and reinstalled to facilitate servicing of the electronics, wiring, and/or conduits.

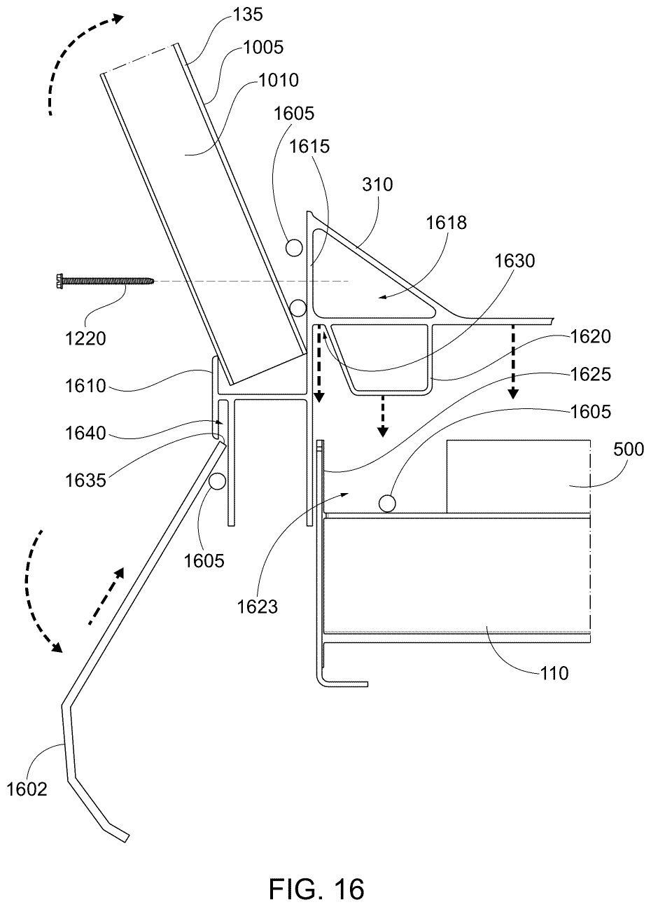

FIG. 16 shows a cross-sectional view of the chassis 110, the sidewall 135, the floor rail 310, and the floor system 500 during assembly. As shown, the sidewall 135 is inserted into the floor rail 310 and rotated into place to promote adhesion of the sidewall 135 to the floor rail 310 in a fashion similar to that as described above with respect to FIG. 12. In this example, the compartment 115 further includes a skirt panel 1602 that is adhesively secured to the floor rail 310 via a similar rotational motion. In the depicted example, one or more floor glue beads 1605 are used to adhere the sidewall 135 and the skirt panel 1602 to the floor rail 310. The floor rail 310 has a retention lip 1610 and an adhesion wall 1615. When secured, the sidewall 135 is secured between the retention lip 1610 and the adhesion wall 1615. To facilitate rotational insertion of the edge of the sidewall 135, the retention lip 1610 is shorter than the adhesion wall 1615. As shown, the floor glue beads 1605 are applied to the adhesion wall 1615. During assembly, the edge of the sidewall 135 is angled between the retention lip 1610 and the adhesion wall 1615. Typically, but not always, the floor rail 310 is positioned at an angle relative to the sidewall 135, and the floor rail 310 is rotated relative to the stationary sidewall 135 due to the sidewall 135 being considerably larger, heavier, and harder to handle as compared to the floor rail 310. When the adhesion wall 1615 is rotated against the interior skin 1005 of the sidewall 135, the floor glue beads 1605 are compressed or squished to promote strong adhesion between the sidewall 135 and the floor rail 310. The adhered surfaces of the sidewall 135 and the floor rail 310 are both high energy surfaces that promote strong adherence. Like in the earlier example, the sidewall fastener 1220, such as a self-tapping screw, is fastened through the exterior side of the sidewall 135 and through the adhesion wall 1615 of the floor rail 310. As can be seen, the floor rail 310 defines a wall cavity 1618 that receives the end of the sidewall fastener 1220. With the end of the sidewall fastener 1220 extending in the wall cavity 1618, the sidewall fastener 1220 is not exposed in the interior compartment so that the passenger compartment has a finished and upscale look.

The floor rail 310 is normally, but not always, attached to the sidewall 135 before the floor rail 310 is attached to the chassis 110 and the floor system 500. As illustrated, the floor rail 310 has a guide rib 1620 that is inserted into a guide channel 1623 that is defined between the floor system 500 and a tongue 1625 of the chassis 110 that generally extends in a vertical direction. The floor rail 310 has a groove 1630 that is defined between the guide rib 1620 and the adhesion wall 1615. The groove 1630 is tapered to promote alignment of the sidewall 135 with the chassis 110 and the floor system 500. During installation, the floor rail 310 with the sidewall 135 is lowered towards the chassis 110 and the floor system 500 such that the guide rib 1620 is received into the guide channel 1623. The tongue 1625 extends into the groove 1630. The tapered shape of the groove 1630 guides the floor rail 310 to facilitate precise alignment of the floor rail 310 and the sidewall 135 with the chassis 110 and the floor system 500 in the lateral direction of the vehicle 105. As shown, at least one floor glue bead 1605 is applied to the chassis 110 in the guide channel 1623 before lowering of the floor rail 310. When the floor rail 310 is fully lowered, the floor glue bead 1605 is compressed between the chassis 110 and the guide rib 1620 of the floor rail 310 to promote bonding. In most versions, the floor rail 310 and the chassis 110 are also connected with mechanical fastening after the floor rail 310 is lowered.

When assembled, the skirt panel 1602 covers the area below the chassis 110 of the vehicle 105. The skirt panel 1602 may need to be replaced during the life of the vehicle 105 because the panels under the floor line of the vehicle 105 are prone to body damage. As shown in FIG. 16, the skirt panel 1602 has an open edge 1635 that is inserted into a trench 1640 defined in the floor rail 310. At least one floor glue bead 1605 is applied to the floor rail 310 proximal to the skirt panel 1602. The skirt panel 1602 is inserted into the trench 1640 at a transverse angle relative to the trench 1640, and the skirt panel 1602 is rotated towards the floor rail 310 so as to compress the floor glue bead 1605 between the floor rail 310 and the skirt panel 1602 which in turn promotes strong adhesion. To replace the skirt panel 1602, the skirt panel 1602 is cut off from the floor rail 310, and the glue is removed. The replacement skirt panel 1602 is then installed in the same way as describe before.

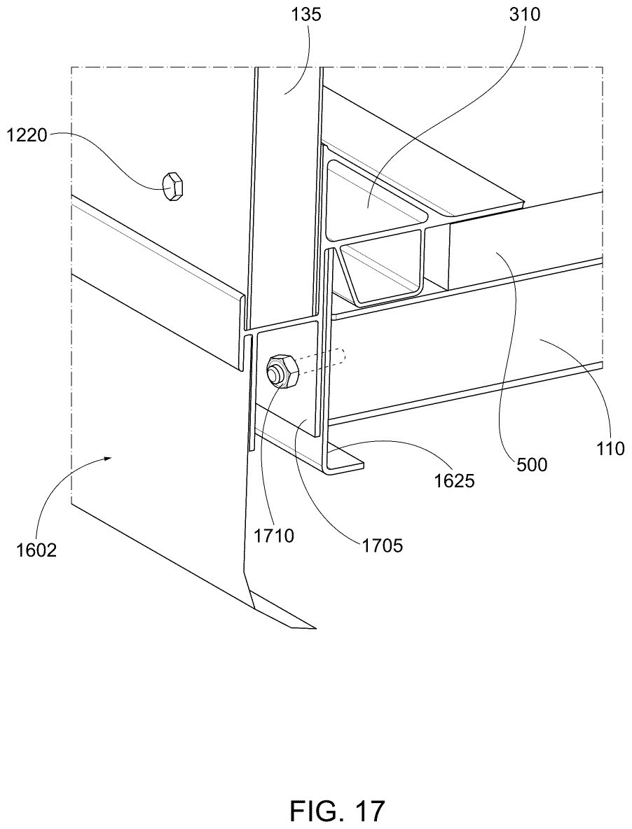

FIG. 17 shows another variation of the chassis 110, the sidewall 135, the floor rail 310, the floor system 500, and the skirt panel 1602 when assembled. In this illustrated example, the floor rail 310 has a flange 1705 that is fastened to the tongue 1625 of the chassis 110 via one or more rail fasteners 1710. As can be seen, the skirt panel 1602 hides the rail fastener 1710 from the outside.

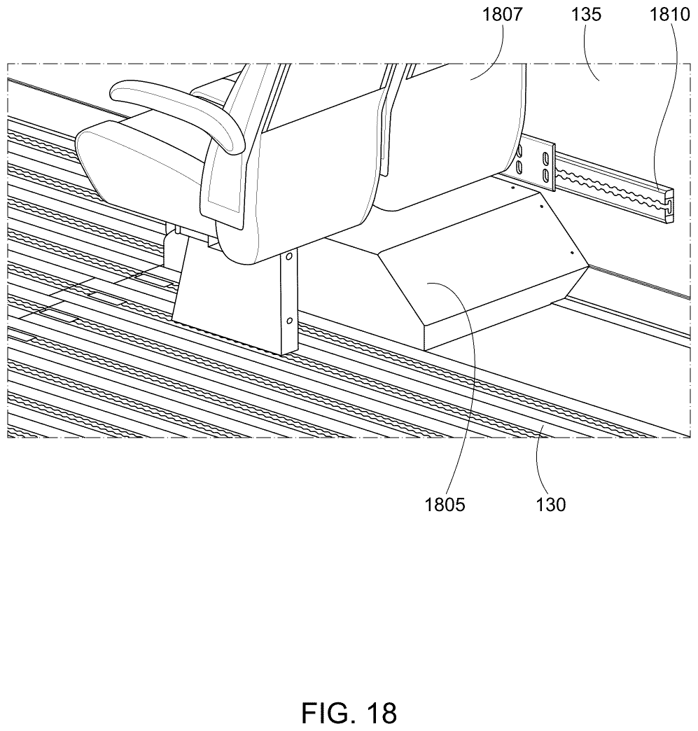

The floor system 500 facilitates the quick changing of seating layouts when needed. However, in the rear wheel area of some vehicles, there is not much space to secure both legs of a seat. As depicted in FIG. 18, a wheel well of the vehicle 105 creates a wheel hump 1805 in the floor 130. The wheel hump 1805 in the floor 130 does not provide adequate floor space to install a seat leg of a seat 1807 at the inboard side located along the sidewall 135. In such cases, the seat 1807 is mounted to the sidewall 135. Such wall mounted seat 1807 must withstand a very high load of two (2) passengers prescribed by FMVSS 207/210. To facilitate strong attachment, a wall track 1810 is glued to the sidewall 135 in such a manner to satisfy such safety tests.

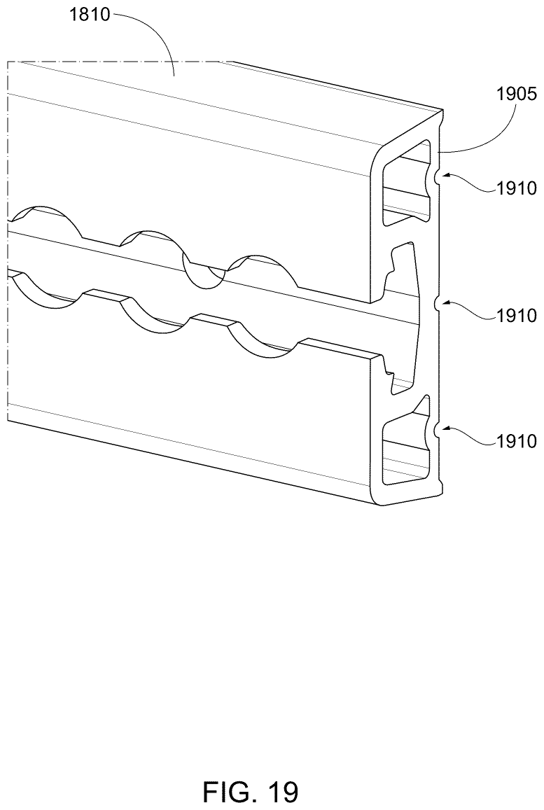

Traditionally, tracks are welded to a steel structure forming the sidewall. However, in the vehicle system 100 described herein, the sidewalls 135 are made from composite sandwich panels which lack steel that can be weld. If was found that embedding a horizontal support member inside the sidewall 135 can be more complex and expensive. The wall track 1810 has been configured to glue to the sidewall 135. To promote strength when the wall track 1810 is glued to the sidewall 135, the wall track 1810 is designed to have a wider base than traditional designs. Looking at FIG. 19, the wall track 1810 has a track base 1905 that is a considerably wider than a standard track to distribute higher loads in the larger area across the sidewall 135. The track base 1905 of the wall track 1810 has one or more scores 1910 that help guide the glue bead and increase surface area for the glue. The wider footprint of the track base 1905 allows the wall track 1810 to withstand the very high loads of an FMVSS 207/210 seat pull test.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Acute” or “Acute Angle” generally refers to an angle smaller than a right angle or less than 90 degrees.

“Adhesive” or “Glue” generally refers to any non-metallic substance applied to one or both surfaces of two separate parts that binds them together and resists their separation. For example, an adhesive can bond both mating surfaces through specific adhesion (e.g., molecular attraction), through mechanical anchoring (e.g., by flowing into holes in porous surfaces), and/or through fusion (e.g., partial solution of both surfaces in the adhesive or its solvent vehicle). Some non-limiting examples of adhesives include liquid adhesives, film adhesives, resin adhesives, rubber adhesives, silicone-based adhesives, mastics, metal-to-metal adhesives, plastic adhesives, rubber adhesives, sprayable adhesives, and hot melt adhesives, to name just a few.

“And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Bolt” generally refers to a type of fastener designed to hold objects together that commonly includes a shaft with threads and a head at one end. In most cases, the head usually has a hexagonal shape, but the head can be shaped different. The bolt is typically made of metal, but the bolt can be made from other materials like plastic. Bolts are typically used with nuts to secure materials. For example, the bolt is passed through a hole in the materials, and the nut is tightened to the threaded shaft on the opposite side opposite to the head to create a strong and stable connection. Bolts are commonly used in construction, machinery, and automotive applications.

“Cavity” generally refers to an empty space in a solid object. The cavity can be completely or partially surrounded by the solid object. For example, the cavity can be opened to the surrounding environment.

“Chassis” generally refers to a load-bearing structural framework of a vehicle that directly or indirectly supports all other components of the vehicle, including (but not limited to) the motor, transmission, suspension, and body. In body-on-frame vehicles, the chassis is a separate, rigid frame providing primary structural support for a separate body of the vehicle as well as the other components of the vehicle. In other words, the chassis in a body-on-frame vehicle is a distinct, rigid frame upon which the body of the vehicle is mounted so as to provide the primary structural support. Body-on-frame vehicles are commonly used in heavy-duty type applications. In unibody vehicles, the functions of the frame and the body are integrated into a single chassis structure that provides enhanced rigidity and fuel efficiency. To say it another way, the chassis and body are integrated into a single, cohesive structure in a unibody type vehicle, where the body panels themselves contribute significantly to the overall strength and rigidity of the vehicle. In both types of vehicle designs, the chassis serves as the main attachment point for components like receiver hitches.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Fiber Reinforced Material” refers generally to any material including fibers of high strength and modulus embedded in or bonded to a matrix with distinct interfaces (boundary) between them. In one example, the fiber reinforced material includes a fiber reinforcement and an encapsulating matrix. A fiber (a fiber or fiber tow typically includes a bundle of filaments) is generally considered to be continuous if the fiber extends from one edge of a ply of material to another edge, most often the opposing edge. While all fibers in a fiber reinforced material need not be continuous, a substantial majority of the fibers will be continuous in some examples.

“Floor” generally refers to the flat base panel of a vehicle where the support structures are mounted. The floor can be made of many different materials such as wood, plastics, metals, rubbers, or a combination of materials. The floor may have tracks or mounting brackets for mounting support structures that are flush with the rest of the floor and/or protrude above the standard floor height. The floor of a vehicle is also the primary area for storage as that is where the items are set. For example, when loading the back of a van, the groceries are typically set on the floor. Additionally, the floor may be covered in a material to make it more comfortable. Some materials used may be carpet, rubber, metals, or leathers.

“Foam” generally refers to materials formed by trapping pockets of gas in a liquid or solid. Solid foams are generally categorized as open-cell-structured foams or closed-cell-structured foams. Open-cell-structured foams contain an interconnected network of pores, whereas closed-cell-structured foams do not have interconnected pores. Certain closed-cell-structured foams, sometimes called syntactic foam, contain hollow particles or beads embedded in the matrix of the material.

“Frame” generally refers to a rigid structural foundation of a body-on-frame vehicle. In the body-on-frame vehicle, the frame and body are separate components that are assembled together. The frame provides the primary support for the motor, transmission, suspension, and/or body. Unlike a unibody construction where the chassis and body are integrated, the frame in a body-on-frame vehicle is a separate entity to which all major components are attached. The frame normally is designed to handle heavy loads and stresses which make the body-on-frame design suitable for trucks and off-road vehicles.

“Hole” generally refers to a hollow portion through a solid body, wall, or a surface. A hole may be any shape. For example, a hole may be, but is not limited to, circular, triangular, or rectangular. A hole may also have varying depths and may extend entirely through the solid body or surface or may extend through only one side of the solid body.

“Lateral” generally refers to being situated on, directed toward, or coming from the side.

“Longitudinal” generally refers to the length or lengthwise dimension of an object, rather than across.

“Oblique” or “Oblique Angle” generally refers to an angle greater than a right angle or greater than 90 degrees.

“Opening” generally refers to a space or hole that something can pass through.

“Plastic” generally refers to a synthetic or semi-synthetic material made from a wide range of organic polymers, such as polyethylene, PVC, nylon, and the like. Typically, but not always, plastics are mostly thermoplastic or thermosetting polymers of high molecular weight and that can be made into objects, films, or filaments. In some cases, plastics can be molded into shape while soft and then set into a rigid or slightly elastic form.

“Seat” generally refers to a type of support structure or a place constructed for the purpose of allowing a human and/or other animal to sit. Some examples of seats include chairs, stools, benches, saddles, and sofas to name just a few. Typically, but not always, the seat can further include a backrest, armrest, and a headrest as well as other features.

“Surface” generally refers to an outermost or uppermost layer of a physical object or space. The surface is typically a portion or region of the object that can first be perceived by an observer using the senses of sight and touch. The surface is usually the portion with which other materials first interact.

“Track” or “Seat Track” generally refers to a mechanical slide structure to which a support structure, such as a vehicle seat, is secured that allows horizontal repositioning or other movement of the support structure.

“Transverse” generally refers to things, axes, straight lines, planes, or geometric shapes extending in a non-parallel and/or crosswise manner relative to one another. For example, when in a transverse arrangement, lines can extend at right angles or perpendicular relative to one another, but the lines can extend at other non-straight angles as well such as at acute, obtuse, or reflex angles. For instance, transverse lines can also form angles greater than zero (0) degrees such that the lines are not parallel. When extending in a transverse manner, the lines or other things do not necessarily have to intersect one another, but they can.

“Unitary” generally refers to a single, continuous entity formed without multiple pieces.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, vans, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

“Wall” generally refers to a side of a room, building, vehicle, and/or compartment that extends from a floor or foundation to a ceiling or roof. The wall in one form may have a planar or multiplanar shape. The wall may be constructed from any of a variety of materials, including, but not limited to metal, concrete, wood, or plastic.

“Wheel Well” generally refers to a recessed cavity or arch-shaped space located above and around a wheel of a vehicle. The wheel well typically houses the wheel and tire assembly, allows for vertical movement during suspension travel, and provides clearance as the wheels turn. The wheel well also can protect the body and undercarriage of the vehicle from debris, water, and mud kicked up by the rotating tires. In some cases, the wheel well further incorporates an inner fender liner for added protection and noise reduction.

“Window” generally refers to an opening or generally transparent panel in a wall of an object that facilitates interior viewing of the object.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### Reference Numbers

100 vehicle system
105 vehicle
110 chassis
115 compartment
120 frame
125 compartment cavity
130 floor
135 sidewall
140 roof
145 rear panel
305 roof rail
310 floor rail
400 roof sandwich panel
405 roof core
410 inner skin
415 outer skin
420 tunnel
425 cutouts
430 stiffeners
435 outer surface
500 floor system
505 track
510 first section
515 second section
520 floor seam
600 floor system
610 first section
615 second section
620 floor seam
705 first panel
710 second panel
715 third panel
720 fourth panel
725 floor covering
730 track cover
805 brace bracket
810 hole
815 brace fastener
820 bolt
905 first hanger
910 second hanger
1005 skin
1010 wall core
1015 side glue bead
1020 end glue bead
1025 resting surface
1030 bonding surface
1035 sidewall connector
1040 roof connector
1045 transition section
1050 sidewall channel
1055 roof recess
1105 opening
1205 retention flange
1210 adhesion flange
1215 indexing tabs
1220 sidewall fastener
1305 track
1310 rain gutter
1315 transition cavity
1320 base
1325 mounting surface
1405 closeout cover
1410 retainers
1415 flexible arms
1602 skirt panel
1605 floor glue bead
1610 retention lip
1615 adhesion wall
1618 wall cavity
1620 guide rib
1620 skirt wall
1623 guide channel
1625 tongue
1630 groove
1635 open edge
1640 trench
1705 flange
1710 rail fastener
1805 wheel hump
1807 seat
1810 wall track
1905 track base
1910 score

What is claimed is:

1. A vehicle system, comprising:
a compartment defining a compartment cavity;
wherein the compartment includes a sandwich panel;
wherein the compartment includes a rail;
wherein the rail is a single-piece extrusion; and
wherein the rail is adhered to the sandwich panel.

2. The vehicle system of claim 1, wherein the rail is made from an aluminum alloy.

3. The vehicle system of claim 2, wherein the aluminum alloy is a 6061-T6 aluminum alloy.

4. The vehicle system of claim 1, further comprising a fastener securing the sandwich panel to the rail.

5. The vehicle system of claim 1, wherein the sandwich panel includes a core covered by one or more skins.

6. The vehicle system of claim 5, wherein:
a glue bead is positioned on one of the skins of the sandwich panel; and
the glue bead is compressed between the rail and the sandwich panel via a rotational motion.

7. The vehicle system of claim 5, wherein:
the compartment includes a roof; and
the roof includes the sandwich panel.

8. The vehicle system of claim 7, wherein:
the core has an exterior surface that is curved;
the core defines a tunnel;
the tunnel is defined in the exterior surface;
the tunnel is centered at the thickest part of the core;
the core has an interior surface;
the core defines a cutout;
the cutout is defined in the interior surface of the core;
the cutout extends transverse to the tunnel;
the sandwich panel has a stiffener; and
the stiffener extends within the cutout.

9. The vehicle system of claim 5, wherein:
the rail includes a roof rail;
the compartment includes a sidewall;
the sidewall includes the sandwich panel;
the roof rail has a sidewall connector connected to the sidewall;
the sidewall connector has a retention flange and an adhesion flange that define a sidewall channel where an edge of the sidewall is received;
the retention flange is shorter than the adhesion flange; and
the roof rail is adhered to the sidewall at the adhesion flange.

10. The vehicle system of claim 9, wherein:
the adhesion flange has one or more indexing tabs;
the compartment has a track; and
the track engages the indexing tabs.

11. The vehicle system of claim 9, wherein:
the roof rail has a retainer;
the compartment has a closeout cover; and
the closeout cover has a flexible arm secured to the retainer.

12. The vehicle system of claim 5, wherein:
the compartment includes a floor;
the compartment includes a sidewall;
the sidewall includes the sandwich panel;
the rail includes a floor rail; and
the floor rail is adhered to the sidewall.

13. The vehicle system of claim 12, wherein:
the floor rail has a retention lip and an adhesion wall receiving the sidewall;
the retention lip is shorter than the adhesion wall; and
the adhesion wall has a glue bead compressed between the adhesion wall and the sidewall.

14. The vehicle system of claim 12, wherein the compartment has a skirt panel adhered to the floor rail.

15. The vehicle system of claim 12, wherein:
the floor defines a guide channel; and
the floor rail has a guide rib received in the guide channel.

16. The vehicle system of claim 12, wherein:
the floor includes a floor system;
the floor system includes tracks assembled together;
the tracks are staggered to form a staggered seam; and
the floor system includes a brace bracket attached across the staggered seam.

17. The vehicle system of claim 12, further comprising:
wherein the compartment has a wall track mounted to the sidewall;
wherein the wall track is adhered to the sandwich panel; and
a seat being secured to the wall track.

18. A vehicle system, comprising:
a compartment including a floor;
wherein the floor is mounted to a frame;
wherein the floor includes a floor system; and
wherein the floor system includes tracks assembled together.

19. A method, comprising:
applying a glue bead;
positioning a sidewall and a rail at a transverse orientation; and
compressing the glue bead via rotational motion relative between the sidewall and the rail.

20. The method of claim 19, further comprising:
wherein the rail is an aluminum extrusion;
wherein the sidewall includes a sandwich panel; and
fastening the sandwich panel to the rail via a self-tapping fastener.
